(19) United States
(12) Patent Application Publication
(10) Pub. No.: US 2013/0328395 A1
(43) Pub. Date: Dec. 12, 2013

(54) Integrated Power Plant and Data Center

(71) Applicant: K2IP Holdings, LLC, West Chester, PA (US)

(72) Inventors: Robert Krizman, Voorhees, NJ (US); Earl Eugene Kern, Malvern, PA (US)

(21) Appl. No.: 13/909,974

(22) Filed: Jun. 4, 2013

Related U.S. Application Data
(60) Provisional application No. 61/655,205, filed on Jun. 4, 2012.

(51) Int. Cl. H02J 4/00

(52) U.S. Cl. CPC H02J 4/00
USPC 307/18

(57) ABSTRACT

A power plant, in the form of a combined heat and power (CHP) plant, may be co-located with a data center to provide redundant electrical power. The CHP plant and the data center may operate as an island, separate from the local electrical-utility grid. The CHP plant may have a redundant fuel source connection to reduce unavailability of fuel for the CHP and increase the uptime of the data center. The CHP plant may include turbines and engines to manage variable loads within the data center. The power plant may include multiple distributions busses in high-availability configurations to provide highly-reliable and high-quality electricity to the data center. The positioning of these elements in the power plant design provides economies of scale and eliminates single points of failure commonly found in data center configurations, increasing the reliability of the data center.

### CROSS-REFERENCE TO RELATED APPLICATIONS

This application claims benefit of priority to U.S. Provisional Patent Application No. 61/655,205 filed on Jun. 4, 2012, and entitled “COMBINATION HIGH AVAILABILITY CHP AND HIGH DENSITY DATA CENTER,” which is hereby incorporated by reference in its entirety.

### FIELD OF THE DISCLOSURE

The instant disclosure relates to a power source. The instant disclosure more specifically relates to redundant and highly-reliable power sources for a data center.

### BACKGROUND

Data centers house large amounts of information technology (IT) equipment, such as servers, data storage devices and network equipment. This equipment has the ability to consume power in excess of 600 watts/square foot (SF). To reduce the amount of real estate occupied by the IT equipment, the equipment is stored in racks or enclosures that allow large quantities of equipment to be compressed into small footprints. However, the density, e.g., compaction of the IT equipment, of current data centers is limited by the availability of adequate, redundant, and reliable publically-available electric power to support both the IT equipment and electro-mechanical cooling of the IT equipment. Thus, data center capacity is generally limited by the amount of power that can be provided by the local electrical-utility grid. In stressed areas and in urban environments, the power limit may be in the range of 20 to 25 megavolt-amperes (MVA). However, many high-density data centers have power loads of 180 MVA or greater. In many areas, the public electrical-utility grid cannot supply this quantity of power. Furthermore, data centers, which have become the nerve cluster of many corporations and internet service providers (ISPs), are critical components that must have both power quality and redundancy to prevent data center outages. Thus, even if the public electrical-utility grid could supply sufficient power, the amount of physical space required to provide the necessary power quality and redundancy required would be extremely large and prohibitive in both physical size and cost.

FIG. 1 is a block diagram illustrating a conventional data center power arrangement. A data center 100 may include connections 102 and 104 to a local electrical-utility grid. The electrical service is supplied to electrical substations 106 and 108 from the connections 102 and 104, respectively. The electrical power from the substations 106 and 108 simultaneously provide power to information technology (IT) equipment in normal operating conditions. Normal power flow to the IT equipment is from substations 106 and 108 respectively through UPSs 114 and 116 and through the PDUs 118 and 120, respectively, to remote power panels (RPPs). When public electrical power is lost, generators 110 and 112 may activate to supply electrical power to the IT equipment and prevent loss of service within the data center. Due to the start-up time of the generators 110 and 112, uninterruptable power supplies (UPS) 114 and 116 are connected in-line between the IT equipment and the generators 110 and 112. The UPSs 114 and 116 include batteries that provide instantaneous power upon loss of the electrical connections 102 and 104.

However, the volume of batteries and supporting equipment increases proportionally to the amount of IT equipment and the load of the IT equipment. For example, the data center 100 must also include paralleling gear coupled to the generators 110 and 112 to support switch-over during public electrical power outages. Furthermore, switches 114A and 116A coupled to the UPSs 114 and 116 are necessary to support switch-over during failures of the UPSs 114 and 116, respectively. Real estate occupied by the batteries and supporting equipment is prohibitive to construction of large high-density data centers. Furthermore, the number and size of the generators 110 and 112 scales with the electrical and cooling load of the IT equipment, which further inhibits development of high-density data centers, as air permitting and space requirements grow with the quantity and size of the generators. Finally, the reliance on public electrical service 102 and 104 and on-site generators 110 and 112 requires the use of complex power conditioning systems, uninterruptable power supplies (UPSs) 114 and 116, and power distribution units (PDUs) 118 and 120 to condition and distribute power to IT equipment.

### SUMMARY

A data center may be powered by a highly-reliable power plant, which may be configured in a combined heat and power (CHP) plant arrangement, such that the data center does not rely on the public electrical-utility grid for primary or tertiary power supply. The power and cooling distribution from the CHP plant may be in a dual output path configuration to provide redundancy in the power and cooling supplied to the data center. In one embodiment, the data center may be separated into modules that are further segmented into pods, such that power and cooling distribution systems may be segmented for redundancy and availability. In one embodiment, the CHP plant may be co-located with the data center.

A power plant may improve the fuel source power generation efficiency by using waste heat from generation as output to other processes, which increases the per-British Thermal Unit (BTU) efficiency of the fuel source. Multiple engines, of multiple types, may be configured in the power plant to allow for concurrent maintainability of the power plant components without affecting availability and redundancy during maintenance. In one embodiment, the power plant may have redundant fuel source connections, such that there is no single failure point for the power plant that would reduce availability of the power and cooling to the data center. The engines may be connected to a segmented bus. The bus may be configured as redundant busses with transient surge suppression and power-drop protection and multiple distribution legs for redundancy and diversity.

On-site electric generation may provide large levels of high-quality electricity to power the data center. On-site electrical generation provides advantages over public utility power, such as allowing for the reduction or elimination of power conditioning equipment and systems in the data center, allowing for the reduction or elimination of all backup diesel generation and fuel oil storage for data center back-up power, increasing power quality as there are no overhead lines subject to interruption or intermediate shorts, reducing voltage sags, harmonics, or power factor correction requirements because there are no other customers to affect power quality, reducing brown-outs or outages due to the electric grid stresses during peak usage periods, reducing public electrical-utility grid transmission and distribution losses, and/or reducing overall environmental emissions because the electric load is generated by natural gas, rather than coal, and the generation plant does not have to produce additional power to overcome typical transmission and distribution losses (estimated at 15% to 20%) and that less overall electricity is required to be produced because the cooling loads are driven by the discharge heat stream, rather than by electric driven motors. A natural gas power plant may have an overall efficiency greater than 75%, while the fossil fuel utility plants have an efficiency of only around 30%. Although natural gas-fired power plants are described herein, other fuel sources may be used at the on-site power plant.

When the power plant is co-located with the data center, energy losses from the utility generation plant to the site may be reduced or eliminated. The co-location of the power plant may generate a significant savings in the quantity of prime energy required to generate electric power, due to reduction or elimination of typical electric transmission and distribution losses on the local electrical-utility grid.

In some embodiments, the power plant may produce excess power, which may be sold to the local electrical-utility grid or another off-taker. In one embodiment, the ability to synchronize to the local electrical-utility grid may provide additional system electrical stability. Electrical power flow may be controlled to increase efficiency between the requirements of the data center and the electrical-utility grid. The use of steady mechanical and electrical loads by IT equipment may allow for the optimization of the controls through specialized algorithms accounting for maximizing the production of electricity and chilled water (or steam) over the entire operating range of a data center. For example, on hot days production of chilled water may be favored over steam. In another example, if the electrical load requirements are high and the cooling loads are low, additional power may be generated through steam-driven electric generators. At times when cooling loads are high, compared to the electrical requirements, steam may be diverted to produce additional cooling. Because the cooling plant may be used primarily to cool non-latent loads, the chilled water temperature may be adjusted to provide maximum efficiency and optimum balance for the electric plant.

In embodiments with a power plant configured in a redundant manner, the electric plant may be configured in an N+y configuration, where N is a number of primary units and y is a number of redundant units. The y redundant units may be operated to provide standby capacity should a loss of any primary unit occur. The y redundant units may also be operated to generate additional electricity for exported to the grid or to local off-takers. At times when excess electrical energy is generated, heat from the prime-mover exhaust discharge may be converted to steam to which will be used to produce additional electric capacity and increase operational efficiency.

A power plant co-located with a data center may be configured to operate in an islanded mode of operation, in which the power plant maintains the required power quality through the use of various generation components and transient load absorbing components. In this configuration, the power plant may be disconnected from the electrical-utility grid and continue to provide uninterrupted power and cooling to the data center. Furthermore, the exhaust heat from the turbines and engines of the power plant may be recovered through the use of absorption chillers to produce chilled water, further reducing the overall quantity of electrical energy production required by the system through the elimination of electrical driven chillers.

The use of dedicated electric and chilled water plants allows for the construction of data centers in locations currently prohibited or challenging due to insufficient and/or unaffordable power availability.

In one embodiment, an apparatus may include a combined heat and power (CHP) plant having redundant power sources and/or provide redundant power generation. For example, the CHP plant may have dual diverse natural gas inputs. In another example, the CHP plant may have redundant engines and turbines for generating power. The redundant power sources, either at the input of the CHP plant or within the CHP plant, reduce the likelihood of a single-point failure within the CHP plant. The apparatus may also include a data center coupled to the power plant. The data center may be co-located with the power plant on the same physical property.

In a further embodiment, a method may include receiving a first fuel source. The method may also include receiving a second fuel source different from the first fuel source. The method may further include generating electrical power from at least one of the first fuel source and the second fuel source in a plant co-located with a data center. The method may also include providing the electrical power to the data center.

The foregoing has outlined rather broadly certain features and technical advantages of embodiments of the present disclosure in order that the detailed description that follows may be better understood. Additional features and advantages will be described hereinafter that form the subject of the claims. It should be appreciated by those having ordinary skill in the art that the specific embodiments disclosed may be readily utilized as a basis for modifying or designing other structures for carrying out the same or similar purposes. It should also be realized that such equivalent constructions do not depart from the spirit and scope of the disclosure as set forth in the appended claims. The novel features that are believed to be characteristic, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a conventional data center power arrangement.

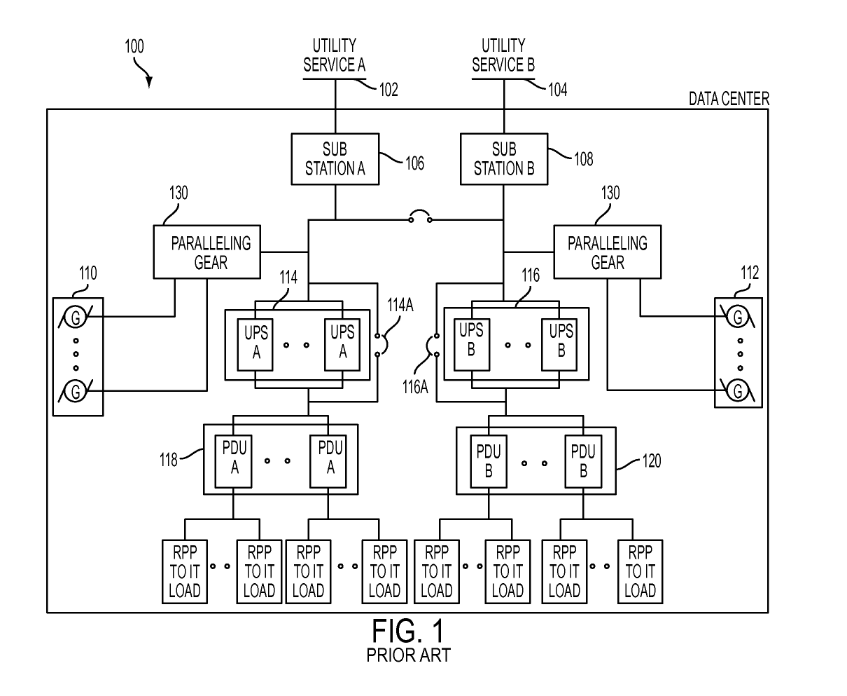

FIG. 2 is a block diagram illustrating a system with a data center co-located with a combined heat and power (CHP) power plant according to one embodiment of the disclosure.

FIG. 3 is a block diagram illustrating connections within a system with a data center co-located with a combined heat and power (CHP) plant according to one embodiment of the disclosure.

FIG. 4 is a block diagram illustrating a configuration of N natural gas turbines and M engines to produce electricity in a redundant manner according to one embodiment of the disclosure.

FIG. 5 is a block diagram illustrating cooling a module of a data center according to one embodiment of the disclosure.

FIG. 6 is a block diagram illustrating electrical distribution within each pod according to one embodiment of the disclosure.

### DETAILED DESCRIPTION

A combined heat and power (CHP) plant may include both electrical and mechanical services. At capacity, the generated electric load and the electric cooling load requirements of a data center may be balanced against the electrical and mechanical services of the CHP plant and provide upward of 75% overall power plant efficiency. This high efficiency may be achieved, for example, through the use of selective heat recovery equipment on the exhaust stream from the turbine and engine generation equipment.

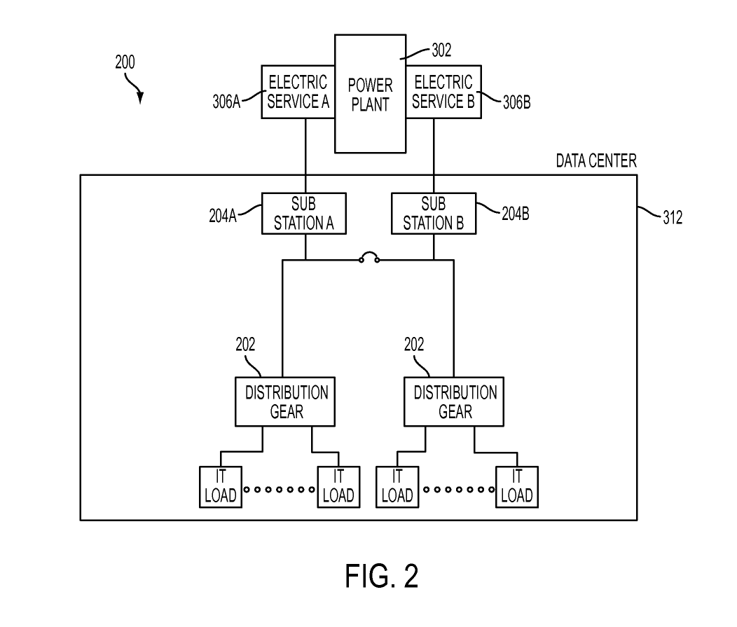

FIG. 2 is a block diagram illustrating a system with a data center co-located with a combined heat and power (CHP) power plant according to one embodiment of the disclosure. In a system 200 with a power plant 302 co-located with a data center 312, the data center 302 may provide two independent electric service buses 306A and 306B. The electric service buses 306A and 306B may be coupled to electric substations 204A and 204B, respectively. A distribution system 202 may be coupled to the substations 204A and 204B for distributing power received from the power plant 302 to IT equipment.

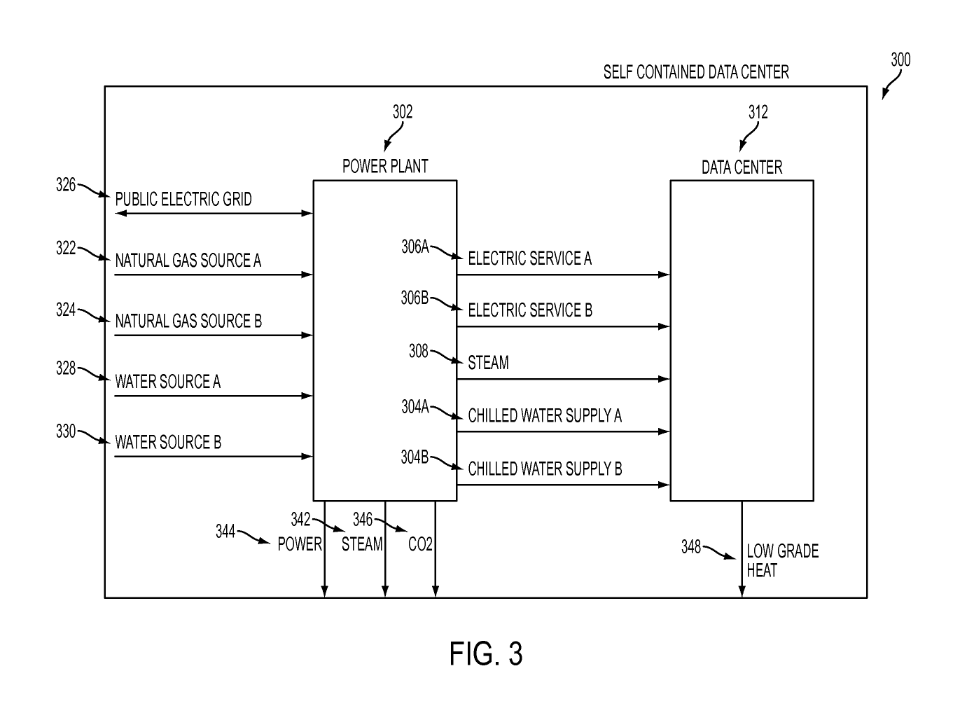

FIG. 3 is a block diagram illustrating a system 300 with a data center co-located with a combined heat and power (CHP) plant according to one embodiment of the disclosure. The power plant 302 may provide chilled water 304A and 304B to a data center 312. Although two redundant water supplies 304A and 304B are shown, additional chilled water supplies may be provided to the data center 312. The power plant 302 may also provide electric service 306A and 306B to the data center 312. Although two electric service connections 306A and 306B are shown, additional electric service connections may be provided to the data center 312. Furthermore, the power plant 302 may provide a steam connection 308 to the data center 312 for heat, humidification and/or other electro-mechanical generation. The power plant 302 may also provide a steam connection 342 and electrical connection 344 to a third-party off-taker for heat and/or other electro-mechanical generation. In one embodiment, the connection 344 may provide an output to sell electric power to other customers in close proximity not requiring connection to the electric grid.

An exhaust gas stream 342 of a power plant 302 may be used to produce steam of sufficient quantity and pressure to drive additional electric generation or for process uses or comfort heating to third-party off takers. The remaining heat, not used in the direct production of additional electricity or chilled water, may be used to pre-heat boiler make-up and for other minor heating loads. Overall the efficiency of the system may be as high or greater than 75% efficient due to the significant and stable cooling requirements of the high-density data center.

The power plant 302 may include a number of natural gas-driven generation units, embodied as a combination of turbines and engine generators, power conditioning devices (PCDs), heat recovery boilers, embodied as either steam or hot water generating units, steam turbine driven generators, and/or absorption chillers, configured in a redundant and concurrently maintainable configuration.

The power plant 302 and the data center 312 may be a single assembly with a closely-coupled arrangement between the data center 312 and the output of the power plant 302. Auxiliary power and cooling production may be optimized to allow greater use of waste heat and provide optimum control over power and cooling though the implementation of proprietary control schemes.

The power plant 302 may be coupled to fuel sources through a first natural gas source 322 and a second natural gas source 324. The two natural gas sources 322 and 324 may couple to independent natural gas stations, such that the availability of uninterrupted natural gas is increased. The power plant 302 may also include a connection 326 to a local electrical-utility grid for either importing or exporting electricity. The natural gas may be supplied from diversely-routed services, each capable of providing full-load capacity in case of a supply disturbance. Although natural gas sources are described herein, other sources of fuel may be provided instead of or in addition to natural gas, such as propane, methane, gasoline, and/or diesel. Likewise, water to the power plant 302 may be provided through two sources 328 and 330, which may be two independent connections from diversely-routed sources, which may include a self-contained well near the power plant 302.

In one embodiment, the only energy input to the site 300 may include the dual diverse natural gas services 322 and 324. The connection 326 may provide an output to sell electric power to other customers and to provide a synchronizing source for the generated power. The connection 326 may provide a black-start capability to the utility grid, VAR, voltage reinforcement or capacity enhancement. A metering system may be coupled to the connection 326 or the connection 344 to measure power provided to other customers or power provided to the local electrical-utility grid.

The power plant 302 may also provide a CO₂ output 346. In one embodiment, the connection 346 may provide an output to collect and refine the emitted CO₂ from the exhaust gas stream and produce high quality CO₂ gas for industrial and food applications.

In one embodiment, the data center 312 may provide a connection 348 for low-grade heat. The low-grade heat may be provided or sold to third-party off-takers, such as for greenhouses, aquaponics and/or hydroponics applications.

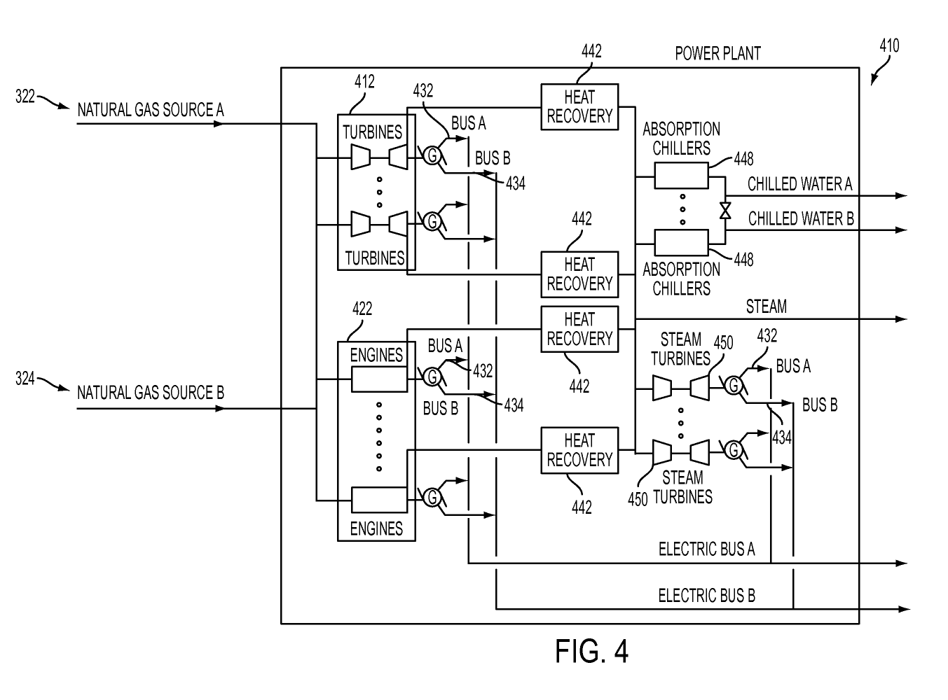

FIG. 4 is a block diagram illustrating a configuration of N natural gas turbines and M engines to produce electricity in a redundant manner according to one embodiment of the disclosure. A power plant 410 may include N turbines 412 and M engines 422. The turbines 412 and engines 422 may provide power to electrical buses 432 and 434. The turbines 412 and engines 422 may also provide exhaust output to one or more heat recovery units 442, such as boilers. The heat recovery units may produce steam for powering one or more absorption chillers 448 and/or one or more steam turbines 450 to generate additional power for electrical buses 432 and 434. In one embodiment, the heat recovery units 442 may be integrated with the absorption chillers 448.

The engines 422 may provide response to changes in load more rapidly than the turbines 412. Each engine 422 may provide distribution to alternate electrical buses 432 and 434, such that a failure on one bus will not affect the other bus. Heat from the exhaust gas stream from both the turbines 412 and the engines 422 may be recovered in the form of steam and hot water. Steam may be produced at high pressure to drive additional electric generation, such as at the turbines 446. Heat from the turbines 412 and the engine exhaust may be recovered and delivered to absorption chillers 448 to produce chilled water. Additionally, hot water may be extracted from the remaining discharge gas stream and may be reclaimed to preheat boiler feed water or some space heating use.

The power plant 410 provides diverse electrical services to a data center. Multiple engines 422 interfaced through multiple buses 432 and 434 may allow for redundant and resilient configurations providing alternate paths should one path become unavailable. The distribution buses 432 and 434 may include minimal surge suppression and power conditioning equipment to support changes in the bus voltage and frequency. The power plant 410 may have the capability of exporting excess power to a local electrical-utility grid when power production exceeds the amount consumed by the data center. In one embodiment, steam may be extracted from an intermediate stage of the steam turbine to provide minimum humidification to the data center and, depending on actual data center load, steam may be exported to additional off-takers.

A mechanical plant may include a combination of absorption chillers and centrifugal chillers configured in a dual-bus arrangement. Electric-driven centrifugal chillers (not shown) may supplement the absorption chillers 448 when additional cooling load is desired and for quick response to changes in the cooling load. During periods when the data center cooling loads are reduced, such as during winter and shoulder periods, the steam and hot water may be exported to local non-data center users. In climates where the full-load operating hours of the chiller plant are low and the humidity levels are within tolerance, the chiller loads may be displaced with refrigerant systems.

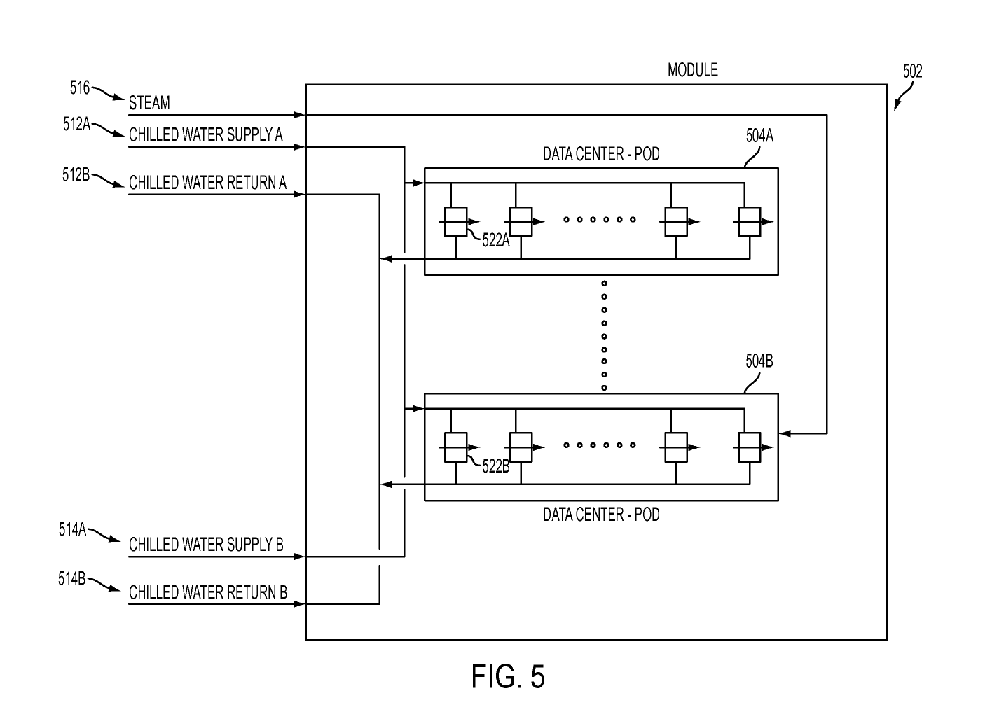

A data center may be configured in a modular configuration where multiple modules are constructed. FIG. 5 is a block diagram illustrating a module of a data center according to one embodiment of the disclosure. Each module 502 may be comprised of a number of smaller enclosures, such as pods 504A and 504B. In certain embodiments, there may be as many as 16 pods in one module. Each of the pods 504A and 504B may operate at different power densities and cooling levels depending on specific client requirements. The pods 504A and 504B may include IT equipment, such as network equipment, routers, switches, storage nodes, and/or servers. The primary cooling for the high-density data center may include filtration of outside air and this air may be ducted into the data center based on proper outside air conditions. In the embodiment of FIG. 5, the pods 504A and 504B may be cooled through redundant chilled water connections 512 and 514 coupled to air handlers, or heat exchangers 522A and 522B, respectively. The water connections 512 and 514 may include both a supply path 512A and 514A and a return path 512B and 514B, respectively.

Although not shown, in one embodiment the pods 504A and 504B may be cooled through the use of DX, or similar, non-water cooled, systems, thereby allowing additional electrical power and steam production depending on the requirements of the specific installation.

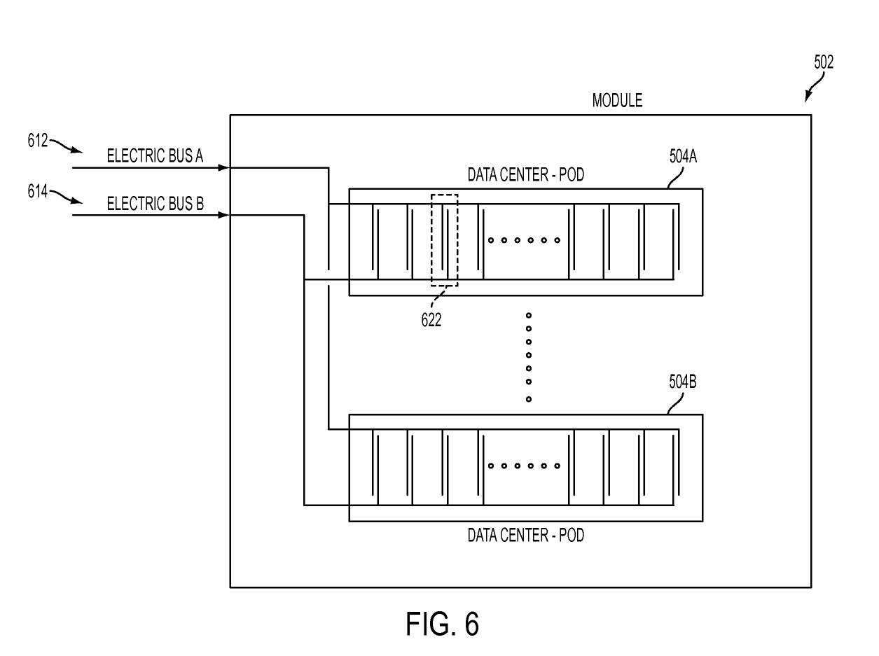

Electrical service may also be distributed in a pod system as described with cooled water in FIG. 5. FIG. 6 is a block diagram illustrating electrical distribution with each pod according to one embodiment of the disclosure. Redundant electrical buses 612 and 614 may provide redundant and independent sources of electric power to IT equipment in each of the pods 504A and 504B. Within the pods 504A and 504B, IT equipment may be arranged on racks, such as rack 622, which includes a connection to the buses 612 and 614.

Although the present disclosure and certain of its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus, comprising:
a power plant having redundant power sources; and
a data center coupled to the power plant,
in which the data center is co-located with the power plant.

2. The apparatus of claim 1, in which the power plant comprises a combined heat and power (CHP) plant.

3. The apparatus of claim 2, in which the redundant power sources of the CHP plant comprise a first connection to a first natural gas station and a second connection to a second natural gas station, the first natural gas station and the second natural gas stations being diverse natural gas stations.

4. The apparatus of claim 2, in which the redundant power source comprises a plurality of natural gas turbines configured in a redundant arrangement.

5. The apparatus of claim 4, in which the redundant power source further comprises a plurality of natural gas engines.

6. The apparatus of claim 5, in which the natural gas engines are configured to provide power to the data center when the load of the data center changes rapidly.

7. The apparatus of claim 2, in which the data center is configured to receive chilled water from the CHP plant though at least two redundant chilled water connections.

8. The apparatus of claim 1, further comprising a connection to a local electrical-utility grid coupled to the power plant, in which the power plant is configured to provide excess-generated power to the local electrical-utility grid.

9. The apparatus of claim 1, further comprising a connection to an electric grid coupled to the power plant, in which the power plant is configured to provide excess-generated power to an off-taker not connected to the local electric-utility grid.

10. The apparatus of claim 2, further comprising a connection to at least one of a hot water and a steam system coupled to the CHP plant, in which the CHP plant is configured to provide at least one of excess hot water and excess steam to the connection.

11. The apparatus of claim 1, in which the data center comprises a plurality of modules, in which each module of the plurality of modules comprises a plurality of pods.

12. The apparatus of claim 11, in which each pod of the plurality of pods comprises information technology (IT) equipment, and each pod of the plurality of pods is coupled to a first electrical service bus and a different second electrical service bus of the power plant.

13. The apparatus of claim 12, in which the IT equipment comprises at least one of network equipment, storage nodes, and servers.

14. The apparatus of claim 1, in which the data center does not include redundant power generation equipment.

15. The apparatus of claim 1, in which the data center does not include uninterruptable power supply (UPS) equipment, power distribution units (PDUs), remote power panels (RPPs), or diesel generators.

16. A method, comprising:
receiving a first fuel source;
receiving a second fuel source different from the first fuel source;
generating electrical power from at least one of the first fuel source and the second fuel source in a plant co-located with a data center; and
providing the electrical power to the data center.

17. The method of claim 16, in which the first fuel source is natural gas, and the second fuel source is natural gas.

18. The method of claim 17, in which the first fuel source is received from a first natural gas station and the second fuel source is received from a second natural gas station different from the first natural gas station.

19. The method of claim 16, further comprising generating heat at the plant co-located with the data center.

20. The method of claim 19, further comprising providing the heat in the form of steam to the data center co-located with the CHP plant.
